(19) United States
(12) Patent Application Publication
(10) Pub. No.: US 2009/0169379 A1
(43) Pub. Date: Jul. 2, 2009

(54) METHODS AND APPARATUS FOR ADVANCED WIND ENERGY CAPTURE SYSTEM

(76) Inventor: Frank McClintic, Toms River, NJ (US)

Correspondence Address: STRAUB & POKOTYLO, 788 Shrewsbury Avenue, TINTON FALLS, NJ, 07724, US

(21) Appl. No.: 12/020,532

(22) Filed: Jan. 26, 2008

Related U.S. Application Data
(60) Provisional application No. 60/886,909, filed on Jan. 26, 2007.

(51) Int. Cl. F03D 7/04; F03D 1/06

(52) U.S. Cl. 416/31; 416/132 B

(57) ABSTRACT

Methods and apparatus of improved wind energy capture system design and operation are discussed. Improved wind energy capture system blade/sail implementations are described. Retractable sails are used in a novel configuration in some but not all implementations. In one embodiment, a turbine blade assembly includes a plurality of uniformly spaced hollow blades. Each hollow blade includes a furling rod onto which a retractable sail can be rolled and stored. Each hollow blade also includes a sail tensioning cable guide for providing tension for a retractable sail included in an adjacent hollow blade. The turbine blades are secured at their root end to a hub assembly. In some but not all embodiments the turbine blades are supported at their tip end, e.g., by using a set of support cables which provide tension. Computer control and automated operations of sail deployment and/or blade adjustments are implemented.

### RELATED APPLICATIONS

This application claims the benefit of provisional U.S. Patent Application Ser. No. 60/886,909 filed Jan. 26, 2007 which is hereby expressly incorporated by reference.

### FIELD OF THE INVENTION

The present invention relates to alternative energy sources, and more particularly, to methods and apparatus, e.g., blade, sails and other assemblies, which can be used to implement a wind energy capture system.

### BACKGROUND

The worldwide appetite for energy has continued to increase as more countries industrialize, and the cost of fossil fuels has also been increasing. There is increased concern with the potential effects of greenhouse gas based global warming. In addition significant safety, security, and environmental issues remain regarding the use of nuclear energy. Therefore, there is a need for improved methods and apparatus for generating energy from clean sources, e.g., wind based energy generation.

One of the limiting factors of the current generation of wind turbines is the structural ability of the supporting tower and turbine blades to handle the dynamic loads to which it is subjected. Due to variable wind conditions and turbulent wind conditions the loads imposed upon the structures can and, and sometimes do, cause the tower to oscillate and cause excessive blade bending. The oscillation and associated bending forces, unless controlled, can cause a premature failure of the structure and induce associated forces and bending loads upon the turbine blades and their support structures.

Typically, these anticipated forces and associated reactions are taken into account in the determining of the sizing of the turbines and the tower structures. The structure is typically designed to meet worst case events over a specified time interval, e.g., a fifty year cycle, as per current design regulations and criteria. This worst case design, in view of expected worst case anticipated tower oscillation, tends to limit size and power generation levels associated with a particular size structure.

Wind conditions will vary over time. A wind blade assembly having a fixed amount of surface area to capture wind energy may be well suited for one set of wind conditions and unsuitable for another set of wind conditions.

It would be beneficial if the cost of a wind energy capture system structure having a given energy output could be reduced and/or the amount of energy a given size wind energy capture system structure can produce could be increased. Methods and apparatus to control stress forces on a support tower would also be advantageous. Methods and apparatus for improved wind blade assemblies would be beneficial. It would be desirable if a wind blade assembly could have a variable surface area so that it could be adjusted to match current wind conditions and/or power output needs.

### SUMMARY

Various features of the present invention are directed to blade and/or sail design which can be used to capture wind energy over a wide range of wind speeds.

Some features of the present invention are directed to blade tip supported blade assembly configurations. Other features are directed to the use of retractable sails and blade modules which facilitate sail deployment and retraction. The blade tip support features and retractable sail features can be used alone or in combination.

In some implementations which use sails, a computer control system is used to control the amount of sail deployed at any given time and/or the amount of tension applied to a sail in at least some but not necessarily all embodiments.

Various features are directed to methods of controlling sail deployment, blade angle and/or other controllable elements of a wind capture system based on one or more of: wind speed, support tower motion, detected strain on a support tower and/or other factors such as whether the wind energy capture system is operating in a start up, power generation and/or emergency mode of operation. As discussed above, various designs use retractable sails. However, the blade tip support features of various embodiments can be used with blades regardless of whether or not retractable sails are used. Similarly it should be appreciated that the retractable sail features can be used in embodiments without blade tip support. However, the combination of blade tip support and retractable sails which is supported in some embodiments can provide a particularly beneficial combination of features.

In accordance with some but not necessarily all embodiments of the invention, in a blade assembly includes a plurality of tip supported blades which are secured to a hub assembly at a root end of the blade. The blades are secured to the hub assembly in a rotatable manner. Thus, the angle of the blade can be changed, e.g., under computer control, thereby varying blade pitch. The hub assembly may be mounted on a drive shaft coupled to, e.g., a generator or hydraulic pump. The drive shaft may, but need not be, an integral part of the hub assembly. In some such embodiments, the tips of the blades may, and in some but not necessarily all embodiments are, supported by a combination of front and rear blade tensioning cables. In addition or alternatively, the tips of the blades may be connected to one another by, e.g., a support ring and/or one or more blade spacing cables. The support ring and or blade spacing cables are connected to the tips of the blades which are included in the blade assembly and help distribute and transfer the force exerted on the blades, from one blade to the next, resulting in a more uniform distribution of forces on the various blades in the blade assembly than may occur if the tips were not connected.

By using a tip supported design, in at least some embodiments, the size of the blades at the root end of the blades can be smaller than might otherwise be possible as compared to more conventional blade assemblies where the tips of the blades are unsupported and each blade must be capable of sustaining the full force on the blade without the help of an additional support member such as a blade tensioning cable, also sometimes called a stay. In some embodiments, a tensioning blade support for supporting a blade is secured to front and rear blade tensioning support cables in addition to the blade, e.g., with the blade passing through the support. In such an implementation, the front and rear blade tensioning cables serve to support the blade and help resist blade bending allowing a thinner and lighter blade to be used than might be the case without the use of blade tensioning cables. In one such embodiment, a front and a rear blade tensioning cable is secured to a hub assembly on which the blades are mounted, e.g., by front and rear cable attachment members, respectively, with the other end of the front and rear tensioning cables being secured to the tip of a blade which they help support. The front and rear blade tensioning attachment members may be implemented as rings to which the blade tensioning cables are attached but can also be of another shape.

In some embodiments which support the use of sails hollow blades are used in combination with retractable sails. Tension cables are used in combination with a rotatable furling rod to control sail deployment and proper sail tensioning. In addition to being used to store the sails when they are in a retracted state, the hollow blades serve as an airfoil and continue to capture wind energy when the sails are fully retracted. The angle of the hollow blades may be altered as a function of wind speed to reduce drag in the case of high winds. This can be done by rotating the blade using a servo located on the hub assembly.

Individual hollow blades and the elements included therein, such as, for example, a sail furling rod, tensioning cable guide, etc., are sometimes referred to as blade modules. In various embodiments, multiple blade modules are secured to a central hub with the hollow blade of each blade module storing a sail which is attached to a furling rod. As the sail is retracted, the sail is wrapped around the furling rod and stored safely within the hollow blade which surrounds the furling rod. As the sail is extended, a tensioning cable attached to an edge of the sail by an attachment member, is reeled in pulling the sail and unfurling it as it extends from the hollow blade. The tensioning cable attached to the edge of a sail can extend around a sail tensioning guide located at a position which results in the tensioning cable pulling on the sail in a direction extending 90 degrees, or approximately 90 degrees, to the length of the furling rod on which the sail to which the tensioning cable is attached, is mounted. Other angles are possible but this angle facilitates smooth and uniform rolling and unrolling of the sail.

By reeling in the sail tensioning cable, the sail to which it is attached is unfurled. In this manner, as the sail of one blade is extended, the tip of the sail is drawn towards the outer tip of the adjacent blade causing the sail to fill in and occupy the space between the blades. Retraction of the sail occurs by rotating the furling rod within a hollow blade to cause the sail attached to the furling rod to wrap around the rod and be drawn into the blade assembly. As sail is wrapped around the furling rod, the tensioning cable is extended allowing the sail to be retracted while maintaining proper sail tension throughout the process. A tensioning servo can be used to set and maintain a desired level of tension on a sail tensioning cable. However, in the presence of a gust of wind, the tensioning cable is allowed to spool out allowing the sail to move rather than tear due to the wind gust.

In various embodiments an odd number of blade assemblies are used. In many such embodiments each blade assembly includes a retractable sail. While an odd number of blade assemblies is used in some embodiments, embodiments with an even number of blade assemblies are also possible.

To maintain proper spacing between blade assemblies, a support ring may be used with the support ring being attached to the tips of the various blade assemblies which form the complete blade apparatus. In other embodiments, wires or cables are strung from blade tip to blade time to provide a connection between the tips of the blade and reduce the chance of uneven blade spacing or excessive distortion during use. In some embodiments, the individual blades are also secured by cables extending towards a hub assembly at an angle to a plane in which the blades rotate. These cables can, and in some embodiments are, automatically adjusted by the control system to apply forward or reverse tension to the blades to reduce blade bending due to the pressure of wind on the individual blades and corresponding sails.

In various embodiments, the wind energy capture system includes a computer control module coupled to one or more sensors, e.g., wind speed, motion and/or strain sensors. The computer control system automatically controls, for example, the amount of sail deployment, sail tension, blade pitch, and/or other controllable features of the wind energy capture system. Strain gauges may be used to detect strain on the tower with actions, e.g., reductions in the amount of sail deployed and/or the pitch of the blades, being automatically taken under computer control when the detected level of strain exceeds a threshold, e.g., a predetermined threshold. The computer control system may also control sail and/or blade deployment to maintain the rotational rate of the blade assembly within a predetermined range as wind conditions vary and/or to control power output, e.g., to maximize or maintain a desired energy output despite changing wind conditions. The computer control system may also control other things such as the position of a counter weight in embodiments which include such a feature. For example, the computer control module can generate a counterweight position control signal to adjust the position of a movable counterweight to dampen tower oscillations detected by a motion sensor. Alternatively, or in addition, the computer control module can generate a counterweight position control signal to adjust the position of a movable counterweight as a function of measured wind speed from the wind speed sensor, the counterweight position being adjusted to at least partially compensate for force on the support tower due to wind.

One exemplary wind blade assembly, in accordance with an exemplary embodiment of the present invention includes: a central hub assembly; and a plurality of blade modules mounted to the central hub assembly, said plurality of blade modules including a first blade module and a second blade module, said first and second blade modules being attached to said central hub assembly at one end. The first blade module including: i) a first hollow blade; ii) a first retractable sail; and iii) a first tensioning cable guide used for guiding a sail tensioning cable which provides tension for a retractable sail included in said second blade module.

Some embodiments include one, more or all of the following features: furling rods located inside hollow blades, lower and upper sail guide roller mounts, air foil shaped blades, pitch adjustable blades, sail tensioning cable guides, e.g., pulleys, located near a blade tip, a sail tensioning cable drum located at a blade root, computerized control for sail deployment including servos and position sensors, automated sail deployment and/or blade adjustment in response to changing wind conditions, tip end blade support via an attachment ring, and tip end blade support via a set of supporting cables.

Some embodiments include a rigid sail attachment member, e.g., of a graphite composite, for attaching a retractable sail to one or more tensioning cables. The sail attachment member may be flat serving not only as an attachment point but also to flatten the edge of the sail. In various embodiments, a sail cable tensioning routing layout is implemented such as to facilitate smooth sail unfurling and sail retraction.

The use of a combination of blade and sail surface area to capture wind energy allows for a lighter weight assembly than would otherwise be needed if only a blade was utilized to capture wind. The addition of the retractable sails allows for adaptability and optimization to a wide dynamic range of wind conditions. While various embodiments have been discussed in the summary above, it should be appreciated that not necessarily all embodiments include the same features and some of the features described above are not necessary but can be desirable in some embodiments. Numerous additional features, embodiments and benefits of the various embodiments are discussed in the detailed description which follows.

### BRIEF DESCRIPTION OF THE DRAWINGS

FIG. 1 is a drawing including an exemplary wind energy capture system assembly implemented in accordance with the present invention.

FIG. 2 is a drawing of an exemplary computer control module, included as part of the wind energy capture system assembly of FIG. 1, implemented in accordance with the present invention and using methods of the present invention.

FIG. 3 is a flowchart of an exemplary method of operating a wind energy capture system assembly in accordance with various embodiments of the present invention.

FIG. 4, which comprises the combination of FIGS. 4A and 4B, is a drawing of a flowchart of an exemplary method of operating a wind energy capture system assembly in accordance with various embodiments of the present invention.

FIG. 5 is a drawing of a front view of an exemplary wind energy capture system including sails in accordance with various embodiments of the present invention and illustrates that the sails which have been unfurled to a first level.

FIG. 6 is a drawing of a front view of the exemplary wind energy capture system of FIG. 5 including sails which have been unfurled to a second level, the second level being higher than the first level illustrated in FIG. 5.

FIG. 7 is a drawing of a side view of an exemplary wind energy capture system in accordance with various embodiments of the present invention.

FIG. 8 is a drawing of a side view of an exemplary wind energy capture system including sails which illustrates various features including features which counteract sway.

FIG. 9 is a drawing of a front view of an exemplary wind energy capture system including sails in accordance with various embodiments of the present invention which illustrates the sails which have been unfurled to a first level.

FIG. 10 is a drawing of a front view of the exemplary wind energy capture system including sails in which the sails have been unfurled to a second level, the second level being higher than the first level indicated by FIG. 9.

FIG. 11 is a drawing of an exemplary root end of a turbine blade module illustrating various features.

FIG. 12 is a drawing of a portion of an exemplary tip end of exemplary turbine blade module illustrating various features.

FIG. 13 is another drawing of an exemplary root end of a turbine blade module, which illustrates additional detail and features.

FIG. 14 is a drawing of an exemplary wind energy capture system in accordance with an exemplary embodiment.

FIG. 15 shows a drawing of the exemplary wind energy capture system of FIG. 14, with the sails unfurled to an intermediate position, e.g., corresponding to a intermediate level of wind.

FIG. 16 shows a drawing of the exemplary wind energy capture system of FIG. 14, with the sails unfurled to an almost maximum position, e.g., corresponding to a very low level of sensed wind.

FIG. 17 shows the steps of a control method implemented by a computerized control system which maybe used with the wind capture system in any of the embodiments with sails shown in the other figures of this application.

### DETAILED DESCRIPTION

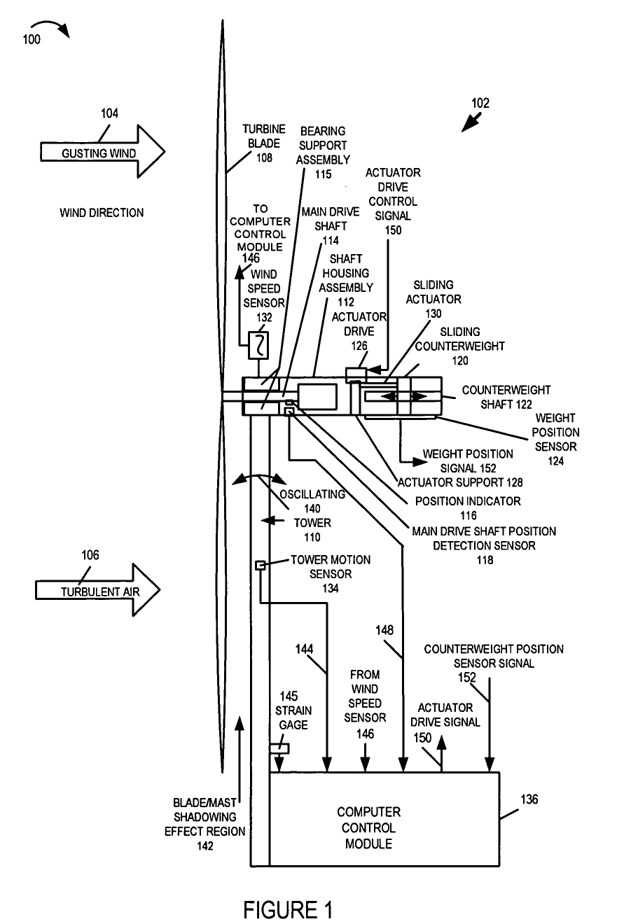

FIG. 1 is a drawing 100 illustrating an exemplary wind energy capture system assembly 102, implemented in accordance with the present invention, being subjected to gusting winds 104 and turbulent air 106. Exemplary wind energy capture system assembly 102 includes a turbine blade assembly 108, a support tower 110, a shaft housing assembly 112, a computer control module 136, a wind speed sensor 132, and a tower motion sensor 134. Shaft housing assembly 112 includes a main drive shaft, a bearing support assembly 115, a position indicator 116, a main dive shaft position detection sensor 118, a sliding counterweight 120, a sliding counterweight shaft 122, a counterweight position sensor 124, an actuator drive 126, an actuator support 128, and a sliding actuator 130. In addition, wind energy capture system 102 includes a wind speed sensor 132 mounted on the shaft housing assembly 112, a tower motion sensor 134 mounted on the tower 110, and a strain gage 145 mounted on the tower 110. In some embodiments the actuator drive and/or counterweight position sensor are omitted and the counterweight is spring loaded by having springs or other tensioning device attached to the weight so that it tends to remain in a stationary position while the housing may move due to wind or other turbulence. Thus, while a drive may be employed springs and/or other devices located on one or both sides of the counterweight may also be used to control the counterweight position thereby achieving an oscillation damping effect without the need for a motor to adjust the position of the counterweight used to stabilize the housing and dampen oscillations.

The turbine blade assembly 108, over time, is subjected to winds at various velocities and turbulent air, resulting in different directional stresses at different times. The variation in wind velocity and/or turbulence level can be due to changing weather conditions. In addition, at least some of the turbulence is due a turbine blade/tower mast shadowing effect in region 142. The presence of the tower 110 causes disruption in air flow in the vicinity of the tower region as the air is forced to flow around the tower mast. The turbine blade assembly 108 is attached to main driveshaft 114 of the shaft housing assembly 112. Bearing support assembly 115 supports the shaft 114 without the housing 112. The shaft housing assembly 112 is attached to tower 110, which tends to move and oscillate as indicated by arrow 140, e.g., as a function of wind velocity and/or turbulence level. Thus, stresses are transferred into the tower 110 tending to bend and oscillate the tower 110.

Wind speed sensor 132 mounted on shaft housing assembly 112 is coupled to computer control module 136. Wind speed sensor 132 measures wind speed, e.g., the speed of gusting wind 104, and communicates the measurement information to computer control module 136, e.g., on an ongoing basis, via signal 146. Tower motion sensor 134, e.g., an inertial sensor module, detects transverse and/or angular motion of tower 110. Motion sensor output signal 144, output from tower motion sensor 134, e.g., on an ongoing basis, is received as input by computer control module 136. The output of the strain gage 145 is also an input to the computer control module 136. While one strain gauge 145 is shown, in various embodiments multiple, e.g., four, strain gauges are placed around the base of the tower, e.g., one at each corner, to measure strain on the tower. While the tower may be stationary, e.g., not oscillating or shaking, under high wind conditions the strain on the tower maybe excessive to the point of being dangerous. The strain gauge or gauges 145 allow tower strain to be measured with the control system responding when detecting a strain exceeding a threshold, e.g., a safety or operating threshold. The strain gauges may be placed at critical structural locations on the tower. Thus, the strain gauges allow tower strain to be measured and controlled, e.g., by the control system automatically retracting sails or changing blade pitch to reduce strain on the tower when the strain exceeds a strain threshold which may be predetermined, e.g., by some safety or operating limit.

Position indicator 116, is attached to main driveshaft 114, while main drive shaft position detection sensor 118 is attached to shaft housing assembly 112. Position indicator 116 operating in conjunction with main drive shaft position detection sensor 118 provides output signal 148 to computer control module 136 providing information that can be used to determine when a blade of turbine blade assembly 108 aligns with the tower 110. In addition, output signal 148 can be used to determine rotational speed of turbine blade assembly 108. In some embodiments, the position indicator 116/detection sensor 118 pair is a magnetic field type device, e.g., a Hall effect sensor. In other embodiments, the position indicator 116/detection sensor 118 pair is an optical type device, e.g., an LED or laser based optical detector module. In still other embodiments, the position indicator 116/detection sensor 118 pair is an electro-mechanical device, e.g., a lobe or lobes on shaft 114 activating a switch.

Sliding counterweight 120 can be controllably moved along counterweight shaft 122 in shaft housing assembly 112. Weight position sensor 124 detects the current position of counterweight 120 and sends counterweight position sensor signal 152 to computer control module 152.

Computer control module 136 processes the received sensor information signals 144, 146, 148 and 152, and generates actuator drive signal 150 which is communicated to actuator drive 126. The actuator drive 126 is, e.g., a mechanical or hydraulic motor. Sliding actuator 130, which is supported by actuator support 128, is controllably moved by the actuator drive 126 in response to received actuator drive control signal 150. Controlled motion of sliding actuator 130 causes controlled motion of sliding counterweight 120. In accordance with the present invention, the placement of and/or motion of the sliding counterweight 120 is controlled such as to reduce oscillations and/or motion of tower 110 and/or reduce stresses between the shaft housing assembly and tower 110.

In some embodiments, position indicator 116/detection sensor 118 and/or weight position sensor 124 are not included. For example, disturbances due to the blade/mast shadowing effect may be determined indirectly through processing of tower motion sensor measurements, and position indicator 116/main drive shaft position detection sensor 118 may be omitted. As another example, the actuator drive 126, sliding actuator 130, and sliding counterweight may have a predetermined known controllable range and weight position sensor is not needed. As still another example, the control loop used for moving the countershaft weight 120 is not concerned with the precise location of the weight 120, but rather drives the weight 120 along the shaft 122 such as to minimize tower 110 oscillations. In some embodiments, load, e.g., resistance due to power generation, on the main drive shaft 114 is measured and used as an additional input to computer control module 136.

In some embodiments, the counterweight is a hydraulic fluid, and a computer control signal controls the pumping of at least some fluid from one location to another to move counterweight. In some embodiments, the counterweight is a multi-part counterweight. In some such embodiments, one part of the counterweight is moved in response to a wind velocity sensor detection signal and another part of the counterweight is moved in response to a tower motion or position detection sensor indication.

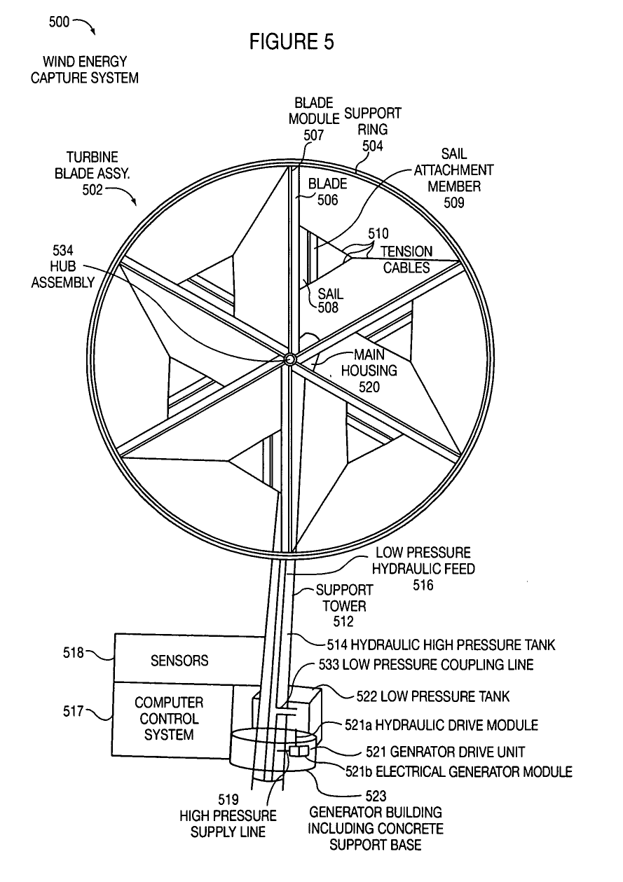

In some embodiments, a turbine blade assembly including retractable sails such as shown in any of FIGS. 5-16 is used in place of turbine blade 108. In such systems including retractable sails additional monitors and servos are included to monitor the amount of sail deployment, monitor sail tensioning cable tension, monitor blade pitch, control sail deployment, control sail tensioning and/or control blade pitch angle setting.

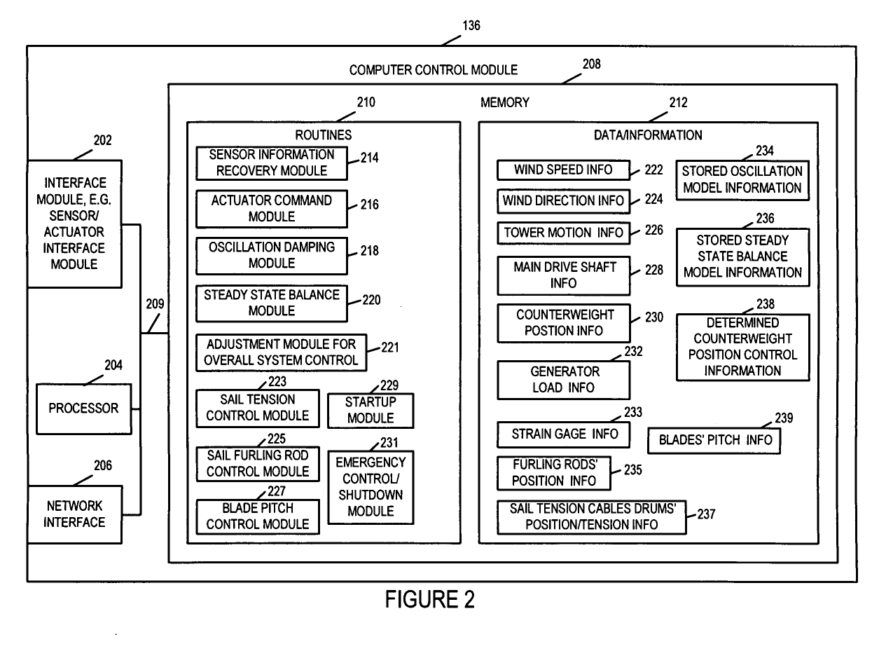

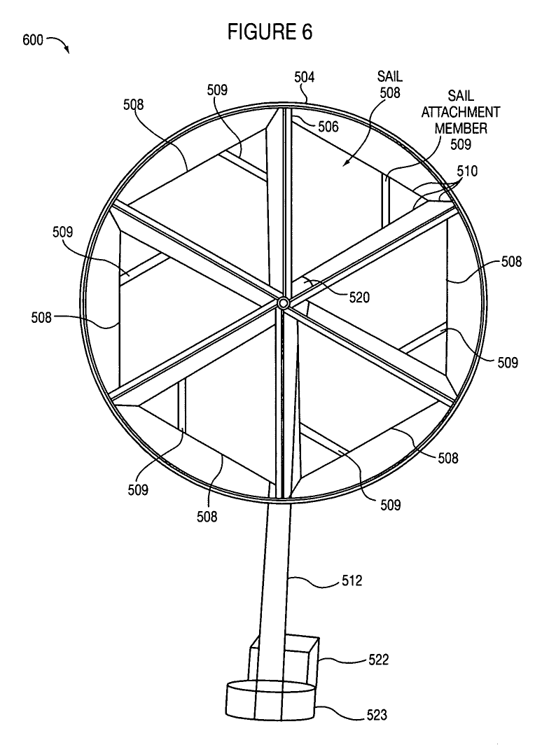

FIG. 2 is a drawing of an exemplary computer control module 136 implemented in accordance with the present invention and using methods of the present invention. Exemplary computer control module 136 includes an interface module 202, a processor 204, a network interface 206, and a memory 208 coupled together via bus 209 over which the various elements interchange data and information. Memory 208 includes routines 210 and data/information 212. The processor 204, e.g., a CPU, executes the routines of 210 and uses the data/information 212 in memory 208 to control the operation of the computer control module 136 and wind energy capture system assembly 102 and implement methods of the present invention. The computer control module shown in FIG. 2 and sensors shown in FIG. 1 can, and in various embodiments are, used with the wind energy capture systems shown in FIGS. 6-10 and 14-16.

Interface module 202, e.g., a sensor/actuator interface module, interface to and receives signals from various sensors, e.g., tower motion sensor signal 144, wind speed sensor signal 146, main drive shaft position sensor signal 148, counterweight position sensor signal 152, a signal from strain gage 145, signals from furling rod position sensors, signals from blade pitch angle sensors, and/or signals from sail tensioning cable tension sensors. Interface module 202 also interfaces to the counterweight actuator drive 126 and sends actuator drive signal 150 to the actuator. In addition, interface module 202 interfaces to servo drives for the furling rods, servo drives for the sail tensioning cable drums, and servo drives for varying blade pitch. The blade pitch servo drives are attached to the individual blades, e.g., one per blade, at the blade root where the blade is attached to the hub assembly.

Network interface 206 couples the computer control module 136 to other network nodes, e.g., a central control node controlling a plurality of wind turbines in the same local vicinity, and/or to the Internet. In some embodiments, at least some of the sensor input information used by computer control module 136 is from sensors located at other sites and/or at least some of the sensor information is communicated via network interface 206. For example, a wind direction sensor may be located at a nearby site and correspond to a plurality of wind turbine systems in the same local vicinity and its information may be communicated via the Internet and network interface 206.

Routines 210 include a sensor information recovery module 214, an actuator command module 216, an oscillation damping module 218, a steady state balance module 220, an adjustment module for overall system control 221, a sail tension control module 223, a sail furling rod control module 225, a blade pitch control module 227, a startup module 229, and an emergency control/shutdown module 231. Data/information 212 includes wind speed information 222, wind direction information 224, tower motion information 226, main drive shaft information 228, counterweight position information 230, generator load information 232, stored oscillation model information 234, stored steady state balance model information 236, determined counterweight position control information 238, strain gage information 233, furling rods' position information 235, sail tension cables drums position/tension information 237, and blades' pitch information 239 and strain limit/threshold information 241.

Sensor information recovery module 214 processes signals from various sensors, e.g., tower motion sensor signal, tower position sensor signal, wind speed sensor, counterweight position sensor, shaft position sensor, strain sensor information, etc. Oscillating damping module 218, uses data/information 212 including tower motion information 226 and stored oscillation model information 234 to determine damping adjustments, e.g., determine counterweight positioning control to respond to tower motion sensor detected oscillations. Steady state balance module 220 uses data/information 212 including wind speed information 222 and stored steady state balance model information 236 to determine counterweight balance positioning to respond to steady state or relatively slow time varying conditions, e.g., determine a counterweight position to at least partially compensate for force on the support tower due to wind, e.g., a steady state wind level.

Actuator command module 216 uses determinations of oscillation damping module 218 and/or steady state balance module 220, e.g., information 228, to generate actuator control signals used to reposition the counterweight. Feedback information such as counterweight position information 230 is also utilized by actuator command module 216. Actuator command module 216 also generates control signals to drive the sail tensioning cable drums' servos, the furling rods' servos and servos to control turbine blade pitch.

Wind speed information 222 includes information from a wind sensor. Wind direction information 224 includes information from a wind direction sensor. Tower motion information 226 includes information from a tower motion sensor and/or tower position sensor. Main drive shaft information 228 includes information from a drive shaft sensor, e.g., shaft position information and/or shaft rate information. Counterweight position information 230 includes countershaft weight sensor information. Generator load information 232 includes information from a sensor measuring output generator load. Determined counterweight position control information 238 includes information determined by oscillation damping module 218 and/or steady state balance module 220.

Stored oscillation model information 234 includes information that relates anticipated detectable oscillation levels to counterweight repositioning information, e.g., for achieving compensation. Stored steady state balance model information 236 includes information that relates anticipated detectable wind speed levels to counterweight repositioning information, e.g., for achieving compensation. Stored steady state balance model information 236 also includes information pertaining to sail deployment, e.g., a tension level to be maintained in the sail tensioning cables. In some embodiments, the stored oscillation model information 234 and/or stored steady state balance model information 236 includes an initial predetermined baseline model. In some embodiments, as the windmill assembly operates, the stored models 234 and/or 236 are refined, e.g., with the computer control module 136 performing learning operations to customize model parameters to the particular wind energy capture system structure, set of operating conditions, and/or sensors available.

The adjustment module for overall system control 221 processes various recovered sensor inputs, e.g. wind speed information, wind direction information, tower motion information, sail furling rods' position information, sail tensioning cable drums' position, sail tensioning cables tension information, blade pitch angle information, strain information, and determines an overall turbine blade assembly deployment strategy. Adjustment module 221 sends signals to sail tension control module 223, sail furling rod control module 225 and blade pitch control module 227 to coordinate their actions and achieve and/or maintain a desired turbine blade assembly deployment. For example, sail furling rod operation is controlled, e.g. in unison with sail tension control, to retract a sail under the overall control of module 221 which coordinates operations. Or furling rod operation is controlled, e.g. in unison with sail tension control to increase the area of sail area deployed automatically in response to a drop in average wind speed, under the overall control of module 221 which coordinates their control operations.

Sail tensioning control module 223 is used for controlling the sail tensioning servo to adjust and/or maintain a determined amount of tension on a sail tensioning cable. Sail furling rod control module 225 is used for controlling rotation of the furling drums and/or locking the furling drums in position. Blade pitch control module 227 is used for controlling blade pitch. In some embodiments, various control determinations and/or signal generated by modules 223, 225, and/or 227 are formatted and communicated via command module 216 via interface module 202, e.g., to the appropriate servo.

Start-up module 229 controls initial start-up of the wind energy capture system including initial turbine blade pitch angle setting, and initial sail deployment, e.g., based on current wind conditions and/or current energy outputs needs. Emergency control/shutdown module 231 monitors for emergency conditions and controls shutdown when an emergency condition has been detected. Emergency conditions include, e.g., natural environment conditions, e.g., a storm in which wind speeds or wind variations exceed a maximum level for safe operation of the wind turbine, wind speeds or wind variations which exceed a maximum level for safe operation of the wind turbine using sail deployment. In some embodiments, emergency shutdowns can shutdown a portion of the energy capture system while leaving another portion to operation. For example, conditions may preclude any sail deployment, yet still allow turbine blades to be pitch adjusted and capture wind energy. Other weather conditions which may be detected and result in a partial or full shutdown include snow, ice, and hail conditions. Emergency control/shutdown module 231 also detects for hardware problems and/or failures and executes shutdowns in response to a detected problem, e.g., an intermittent or failed position or tensioning sensor, an erratic servo drive, a damaged sail, etc.

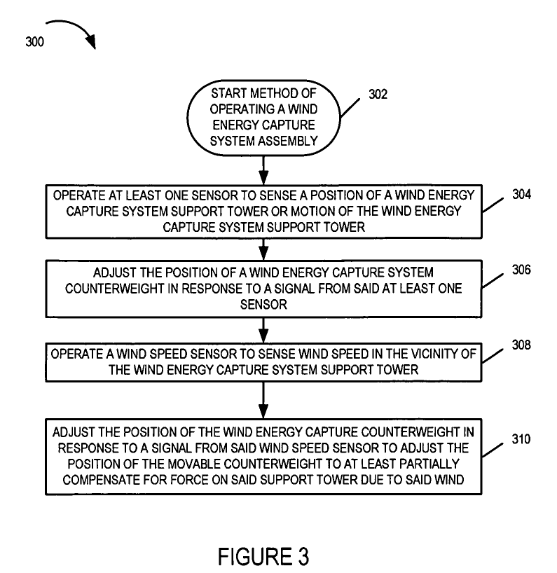

FIG. 3 is a flowchart of an exemplary method of operating a wind energy capture system assembly in accordance with various embodiments of the present invention. The wind energy capture system assembly may be exemplary wind turbine assembly 102 of FIG. 1. Operation starts in step 302, where the wind energy capture system is initialized. Operation proceeds from step 302 to step 304. In step 304, the wind energy capture system assembly operates at least one sensor to sense a position of a wind energy capture system support tower or motion of the wind energy capture system support tower. Operation proceeds from step 304 to step 306. In step 306, the wind energy capture system assembly adjusts the position of a wind energy capture system counterweight in response to a signal from said at least one sensor. In some embodiments adjusting the position of the wind energy capture system counterweight includes adjusting the counterweight position to dampen windmill support oscillations.

In step 308, the wind energy capture system assembly operates a wind speed sensor to sense wind speed in the vicinity of the wind energy capture system support tower, and then in step 310, the wind energy capture system assembly adjusts the position of the wind energy capture system counterweight in response to a signal from said wind speed sensor to adjust the position of the movable counterweight to at least partially compensate for the force on the support tower due to the wind.

In some embodiments the counterweight is a slidable weight and adjusting the position of the wind energy capture system counterweight includes sliding said counterweight, e.g., on a counterweight shaft. In various embodiments, the counterweight is a liquid and adjusting the position of the windmill counterweight includes pumping at least some of said liquid from one location to another. In various embodiments, the counterweight is a multi-part weight. For example, the counterweight may include a plurality of fixed weights and at least one of said plurality of fixed weight may be repositioned without changing the position of at least one other of said plurality of fixed weights. For example, a first repositionable counterweight may be associated with a wind sensor measurement, and a second repositionable counterweight may be associated with a tower motion sensor measurements. As another example, the counterweight may include a first portion which is a fixed solid mass, e.g., a slidable counterweight, and a second portion which is a liquid counterweight. For example, the liquid counterweight portion may be used primarily for a steady state balance level, and the slidable fixed solid mass may be moved to respond to dampen tower oscillations. Different time constants may be associated with the control loops of the two different portions.

In various embodiments, adjusting the position of the wind energy capture system counterweight includes operating a computer module to generate a counterweight position control signal as a function of said at least one sensor. In various embodiments, adjusting the position of the wind energy capture system counterweight includes operating a computer module to generate a counterweight position control signal as a function of said at wind speed sensor signal. The computer module, in some embodiments, includes and uses stored oscillation model information, e.g., modeling information relating sensor detected tower oscillation levels and/or profiles to counterweight repositioning control information and/or stored steady state balance model information, e.g., modeling information relating steady state wind speed levels to counterweight repositioning control information.

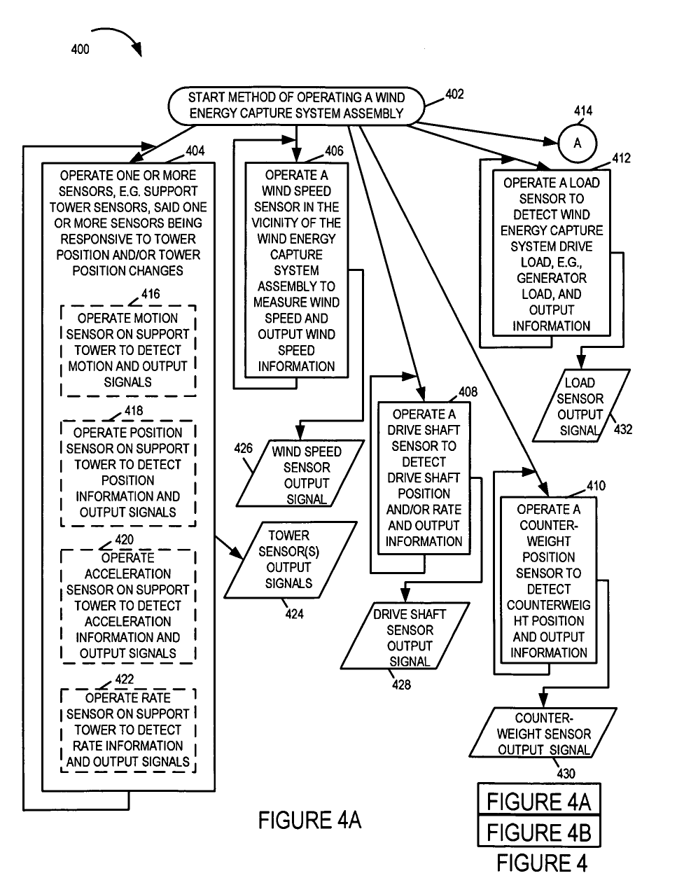

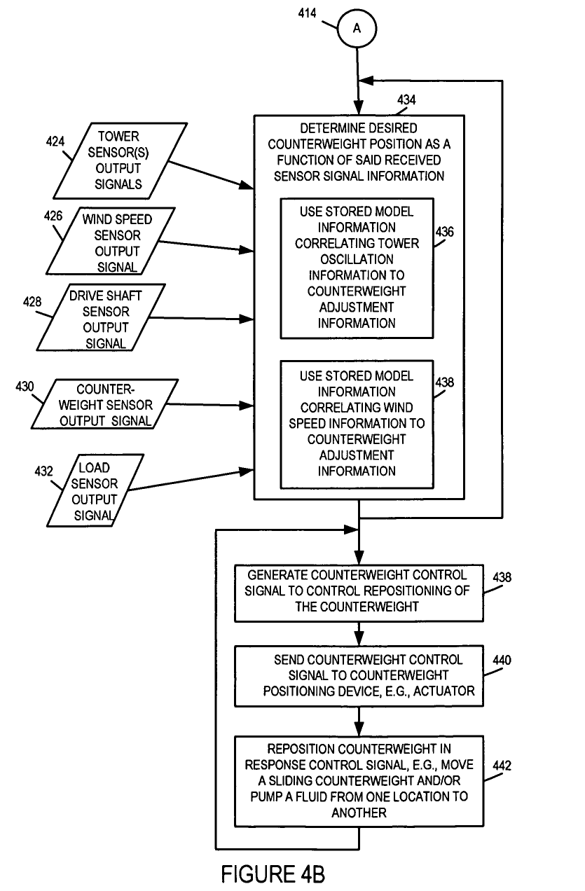

FIG. 4 is a drawing of a flowchart 400 of an exemplary method of operating a wind energy capture system assembly in accordance with various embodiments of the present invention. The wind energy capture system assembly may be exemplary wind energy capture system assembly 102 of FIG. 1. A computer control module included as part of the wind energy capture system assembly may be used for implementing at least some of the steps of the method of flowchart 400. Operation starts in step 402 where the wind energy capture system assembly is powered on and initialized. Operation proceeds from start step 402 to steps 404, 406, 408, 410, 412, and 432 via connecting node A 414.

In step 404, which is performed on a recurring basis, the wind energy capture system assembly operates one or support tower sensors of the wind energy capture system assembly, the said one or more sensors being responsive to tower position and/or tower position changes. Tower sensor(s) output signals 424 is an output of step 404 and is used as an input in step 434.

In some embodiments, at least some or the support tower sensor are mounted on the support tower, e.g., an accelerometer, gyroscope, and/or other inertial measurement instrument attached to the tower. In some embodiments, at least a portion of a support tower sensor assembly is not attached to the tower but is used in detecting tower position and/or tower position changes. For example, a tower position sensor assembly may include a laser beam source and one or more light and/or heat sensitive detection devices, and at least one of the laser beam source and said one or more light and/or heat sensitive detection devices is not located on the tower, e.g., it is located on at a stable site in the vicinity of the tower and is not impacted by wind velocity and/or tower vibration, while the other one of the laser beam source and said light assembly is located on the tower.

Step 404 includes one or more of sub-steps 416, 418, 420 and 422. In sub-step 416, the windmill assembly operates a motion sensor, e.g., vibration sensor, shock sensor, sway sensor, oscillatory motion sensor, mercury switch sensor, etc., on the support tower to detect motion and output signals. In sub-step 418, the wind energy capture system assembly operates a position sensor, e.g., an encoder, a resolver, a synchro, an optical sensor, a linear position sensor, a GPS module, etc., on the support tower to detect motion information and output signals. In sub-step 420, the wind energy capture system assembly operates an acceleration sensor, e.g., a set of accelerometers on the support tower used to detect acceleration information and output signals, said signals including acceleration information and/or information derived from the measurements, e.g., velocity information and/or position information. In sub-step 422, the wind energy capture system assembly operates a rate sensor, e.g., a rate gyroscope, on the support tower to detect rate information and output signals.

In step 406, which is performed on a recurring basis, the wind energy capture system assembly operates a wind speed sensor in the vicinity of the wind energy capture system assembly to measure wind speed and output wind speed information. Wind speed sensor output signal 426 is an output of step 406 and is used as input in step 434. In some embodiments wind direction is also measured and utilized in step 434.

In step 408, which is performed on a recurring basis, the wind energy capture system assembly operates a drive shaft sensor to detect drive shaft position and/or rate and output information. Drive shaft sensor output signal 428 is an output of step 408 and an input to step 424. Drive shaft sensor position and/or rate can be useful in determining when a turbine blade will align with the tower and turbine rate of rotation, useful information when attempting to compensate for tower oscillations due to air turbulence and/or vibration balance considerations.

In step 410, the wind energy capture system assembly operates a counterweight position sensor to detect counterweight position and output information. Counterweight sensor output signal 430 is an output of step 410 and used in step 434 as input. The counterweight position information is advantageous in a closed loop control implementation of the counterweight repositioning.

In step 412, which is performed on a recurring basis, the wind energy capture system assembly operates a load sensor to detect wind energy capture system drive load, e.g., generator load, and output information. Load sensor output signal 432 is an output of step 412 and used as input in step 434. Different generator loads on the wind energy capture system can cause different motion responses at the tower, and such information may be useful in controlling tower motion and/or stresses.

In step 434, which is performed on a recurring basis, the wind energy capture system assembly determines a desired counterweight position as a function of the received sensor information (424, 426, 428, 430, 432). Step 434 includes sub-steps 436 and 438. In sub-step 436, the wind energy capture system assembly uses stored model information correlating tower oscillation information to counterweight adjustment information, while in sub-step 438, the wind energy capture system assembly uses stored model information correlation wind speed information, e.g., steady state wind speed information, to counterweight adjustment information. In some embodiments sub-step 436 includes determining oscillatory counterweight positioning control information including at least two of an amplitude value, a frequency value and a phase value.

Operation proceeds from step 434 to step 438, in which the wind energy capture system assembly generates a counterweight control signal to control repositioning of the counterweight. Then, in step 440, the wind energy capture system assembly sends the generated counterweight control signal to a counterweight positioning device, e.g., an actuator. Operation proceeds from step 440 to step 442, where the wind energy capture system assembly repositions the counterweight in response to a control signal, e.g., moving a sliding counterweight and/or pumping fluid from one location to another. Steps 438, 440 and 442 are performed on a recurring basis, e.g. with one iteration being performed in response to an output from step 434.

FIG. 5 is a drawing of a front view of an exemplary wind energy capture system 500 including sails in accordance with various embodiments of the present invention and illustrates that the sails which have been unfurled to a first level. Exemplary wind energy capture system 500 includes a turbine blade assembly 502, a main housing 520, a support tower 512, a generator drive building 523 including a concrete support base, a computer control system 517 and sensors 518. In this exemplary embodiment, the main housing 520 includes a hydraulic pump and the support tower includes a low pressure hydraulic feed 516 for the hydraulic pump inlet. A hydraulic high pressure tank 514 is coupled to the output of the hydraulic pump. Located at the generator drive building 523 is a low pressure tank 522 coupled to low pressure hydraulic feed line 516 via coupling 533 for supplying hydraulic fluid to the hydraulic pump. High pressure tank 514, e.g., for storing energy is, in this embodiment, located in the support tower 512. However, in other embodiments, the high pressure tank 514 may be located either wholly or partially outside the support tower 512, e.g., the high pressure tank 514 may be located in generator drive building 523. In some embodiments, nitrogen is used in combination with hydraulic fluid to store energy. Generator drive unit 521 also included at generator drive building 523 is, in some embodiments, driven using high pressure hydraulic fluid. High pressure supply line 519 couples the high pressure tank 514 to hydraulic drive unit module 521a of the generator drive unit 521. Electrical power generation module 521b of the generator drive unit 521, which is coupled to the hydraulic drive unit 521a, is an electric power generation device. In some other embodiments, an electric power generator is driven through a mechanical coupling to the turbine blade assembly, e.g., including gearing and shafts. In some such embodiments, the electrical power generator is located in the main housing 520.

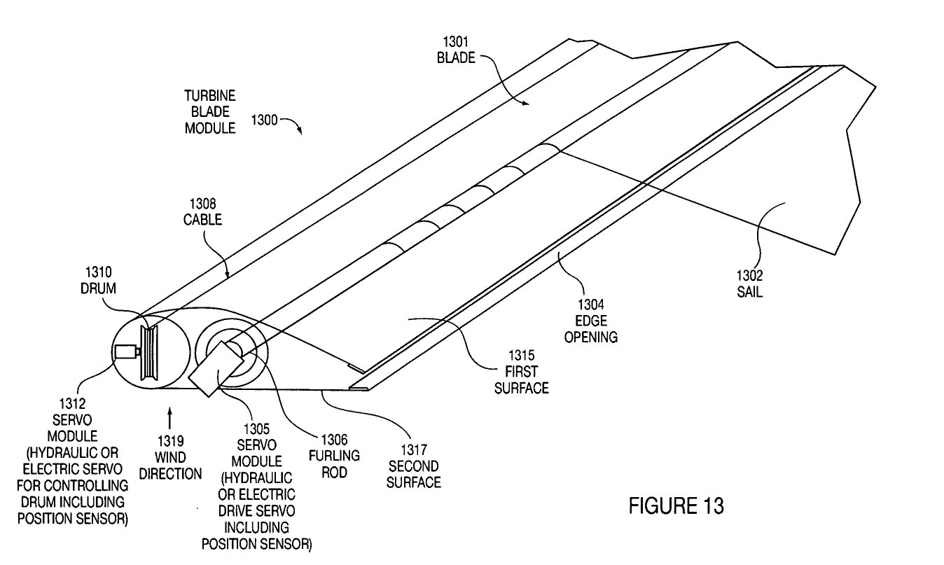

Turbine blade assembly 502 includes an outer support ring 504, a plurality of blade modules 507 each blade module include a blade 506, a plurality of sails 508, a plurality of sail attachment members 509 and a plurality of tensioning cables 510. Sensors 518 are distributed throughout the wind energy capture system 500, and used by computer control system 516 in sail deployment and other various control determinations and operations. Computer control system 517 includes a processor, memory and an I/O interface. The Memory includes routines and data/information. The processor, e.g., a CPU, executes the routines and uses the data/information in memory to control the operation of the wind energy capture system 500 and implement various methods in accordance with the present invention. In some embodiments, computer control system 517 is computer control module 136 of FIG. 2. Sensors 518 include various sensors, e.g., various sensors described with respect to FIGS. 1 and 13. Sensors 518 include, e.g., furling rod position sensors, tensioning cable drum position and/or tension sensors, other sail position/deployment sensors, blade pitch sensors, wind speed sensors, temperature sensors, sway sensors, strain sensors, counterweight sensors, tower motion sensors, and oscillation sensors.

Each of the plurality of blade modules 507 are mounted to a central hub assembly 534 at one end, sometimes referred to as the root end of the blade module 507. The central hub assembly 534 is coupled to on a shaft extending from main housing 520. In this exemplary embodiment, the other ends of the blade modules 507, sometimes referred to as the tip ends, are attached to support ring 504. In some other embodiments, support ring 504 is omitted and blade support tensioning cables are employed to support the tip ends of the blade modules 507. In some embodiments a combination of a support ring 504 or support structure are used in combination with tensioning cables to support the tip ends of the blade modules 507.

A blade module 507 includes a hollow blade 506 and a retractable sail 508. The blade assembly 507 also includes a tensioning cable guide used for guiding a sail tensioning cable which provides tension for a retractable sail included in adjacent blade module. The blade module 507 also includes a furling rod for furling and unfurling the sail 508. A sail 508 is coupled to sail tensioning cables 510 via a sail attachment member 509, e.g., a graphite composite member providing attachment along the edge of the sail. The sail attachment member 509 is attached to a trailing edge of the sail 508. The sail attachment member 509 is secured to the sail 508 and provides an attachment point for sail tensioning cables 510. It may be observed that a tension cable 510 corresponding to a first sail 508 of a first blade module 507 is routed to a tip of a second blade module, which is an adjacent blade module, where the cable is guided down the hollow blade of the second blade module toward the central hub area.

In the exemplary turbine blade assembly 502 of FIG. 5 the turbine blade assembly has six blade modules 507 secured to the hub assembly 534 and uniformly spaced from one another around the hub. In other embodiments, a different number of blade modules are used which are evenly spaced around the hub assembly. In some embodiments, the turbine blade assembly includes an odd number of blade modules secured to the hub assembly which are uniformly spaced from one another around the hub assembly.

FIG. 6 is a drawing 600 of a front view of the exemplary wind energy capture system 500 including sails 508 wherein the sails 508 have been unfurled to a second level, the second level being higher than the first level illustrated in FIG. 5. Various components of the wind energy capture system 500 illustrated in FIG. 5 are also shown in drawing 600 including the main housing 520, the support tower 512, the generator drive building 523, the low pressure tank 522, the support ring 504, the sail attachment members 509, the blades 506, and the tension cables 510.

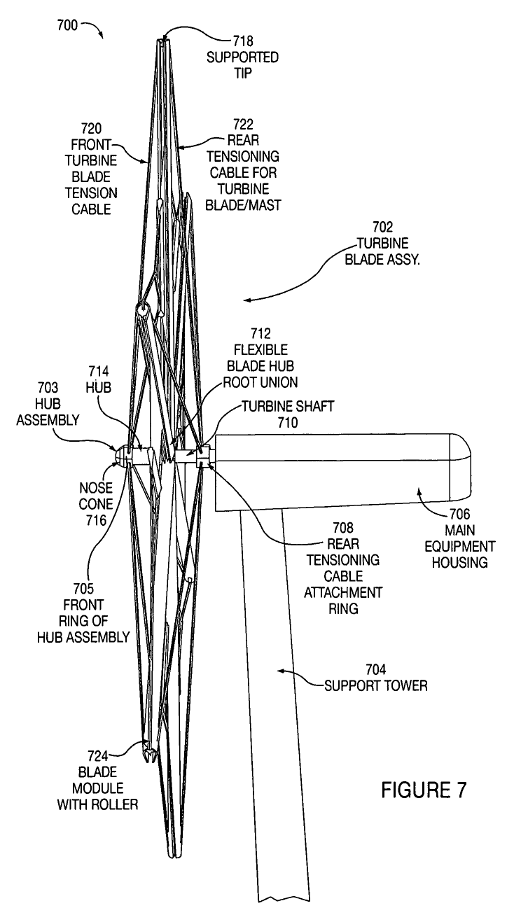

FIG. 7 is a drawing of a side view of an exemplary wind energy capture system 700 in accordance with various embodiments of the present invention. Exemplary wind energy capture system 700 includes a turbine blade assembly 702, a support tower 704, and a main equipment housing 706. Support tower 704 is attached to the main equipment housing 706. Turbine shaft 710 extends from inside the main equipment housing 706 and couples the turbine blade assembly 702 to the equipment within the main equipment housing, e.g., a hydraulic high pressure pump or generator drive units. Turbine blade assembly 702 includes a hub assembly 703 including a rear tensioning cable attachment ring 708, a front ring of the hub assembly 705, which is a front tensioning cable attachment ring, a flexible blade hub root union 712, a hub 714, and a nose cone 716. Turbine blade assembly 702 also includes a plurality of supported tips 718, a plurality of blade module with roller 724, a plurality of front turbine blade tension cables 720, and a plurality of rear tensioning cables for turbine blade/mast 722. Blade modules 724 are attached at their blade root ends to the flexible blade hub root unit of the hub assembly. The flexible blade hub root union 712 allows front to back rocking. The tensioning cables (720, 722) can be fixed or can be movable to allow tensioning adjustments. In some embodiments, the nose cone 716 is controlled to move in and out. For example, the nose cone 716 can be controlled to slide in and out along the hub 714. Alternatively, the nose cone 716 can be fixed to the hub and the hub can be controllably moved in and out to change the tension adjustment. The blade module with roller 724 is part of the furling sail system.

In this exemplary embodiment the blade modules 724 include supported tip ends 718 which are supported using tensioning cables. Front turbine blade tensioning cables 720 run from a blade module tip end 718 to front ring of hub assembly 705. Rear tensioning cables for turbine blade/mast 722 run from a blade module tip end 718 to rear tensioning cable attachment ring 708.

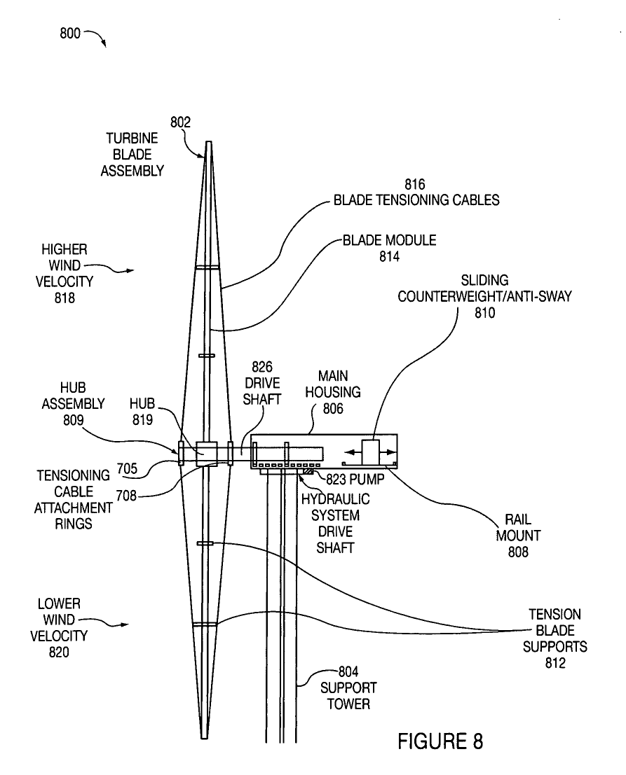

FIG. 8 is a drawing of a side view of an exemplary wind energy capture system 800 including sails which illustrates various features including features which counteract sway. FIG. 8 also illustrates additional features of the blade tensioning system. Exemplary wind energy capture system 800 includes a turbine blade assembly 802, a support tower 804, and a main housing 806. Main housing 806 includes a hydraulic system drive shaft 826 coupled to a hydraulic high pressure pump 823, a rail mount 808 and a sliding counterweight 810. In some embodiments, sliding counterweight can be controllable positioned, e.g. via computer control, along the rail mount 808 to counteract sway. In some embodiments, the sliding counterweight 810 is spring loaded and the weight is moved by inertial control, e.g., the weight moves to counter tower motion damping oscillations from wind gusts and/or varying forces on the blades such as higher and lower wind velocities. For example, sway may be introduced via wind 818 above the main housing having a higher wind velocity than wind 820 below the main housing. Sway may also be instructed by the changes in wind velocity occurring at both upper and lower portions concurrently. Sway may also be caused by changes in drive load being applied to the turbine output. In any event, the counterweight position variation can counteract sway. Turbine blade assembly 802 includes a hub assembly 809, a plurality of blade modules 814, a plurality of blade tensioning cables 816, and a plurality of tension blade supports 812, Hub assembly 809 includes a hub 819 and tensioning cable attachment members, e.g., rings (705, 708). Hub assembly 809 is attached to drive shaft 826. The drive shaft and attachment rings may but need not be integral members of the hub assembly. The root end of the blade modules 814 are attached to the hub 819. Blade tensioning cables 816 extend from the tip ends of the blade modules 814 to the tensioning cable attachment rings (705, 708). Tension blade supports 812, mounted along the blade modules 814, provide further support and increase the rigidity of the structure. The blade of each blade module passes through a tension blade support 812 which the tension blade support stiffening the blade.

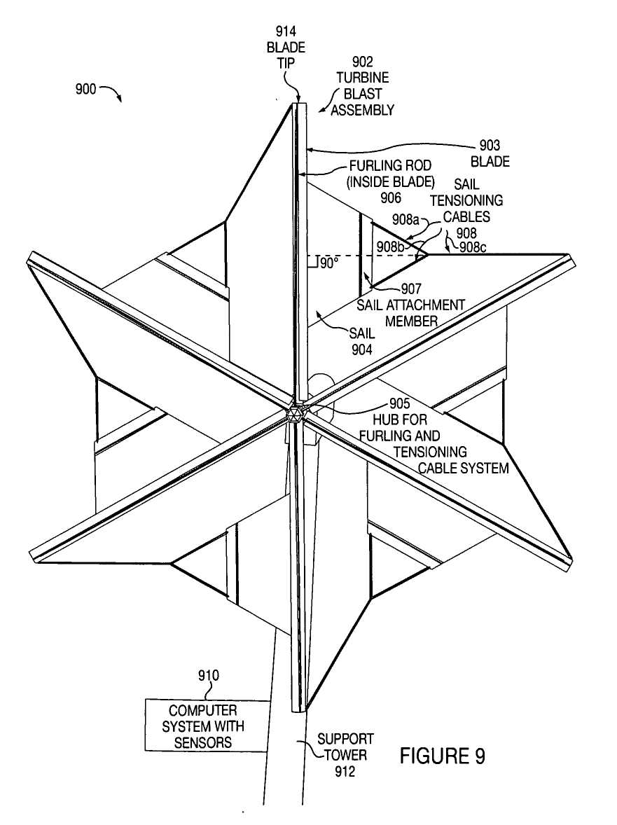

FIG. 9 is a drawing of a front view of an exemplary wind energy capture system 900 including sails in accordance with various embodiments of the present invention. FIG. 9 illustrates that the sails have been unfurled to a first level. Wind energy capture system 900 includes a turbine blade assembly 902, a support tower 912, and a computer system with sensors 910. Turbine blade assembly 902 includes a plurality of: a hollow blade 903 with a blade tip 914, a furling rod 906 which is inside the blade 903, a sail attachment member 907, a sail 904, and sail tensioning cables (908a, 908b, 908c). Sail 904 can be controllably rolled up on furling rod 906 inside hollow blade 903. Turbine blade assembly 902 also includes a hub assembly 905 including attachments for the furling and tensioning cable system.

In accordance with one feature of this embodiment, the sail tensioning cable 908c is intentionally oriented at a 90 degree angle with respect to the furling rod 906 with regard to the portion of sail tension cable 908c between the tensioning cable junction point, where cables 908a, 908b and 908c meet, and the tip of the adjacent blade through which cable 908c is routed for spooling operations which occur at the hub 905. This feature facilitates smooth furling and unfurling operations. This feature also allows for sail 904 to be unfurled by spooling in single sail tensioning cable 908c. This feature also allows for sail 904 tension to be controlled, e.g., during a furling in operations by controlling tension on single sail tension cable 908c. This approach is in contrast to other more complex implementations, where the sail tension cable angle is other than 90 degrees and multiple sail tensioning cables attached to multiple spooling devices are used to control tension on a single sail.

In accordance with another feature of this embodiment, the sail attachment member 907 is rigid and flat. In some embodiments, the sail attachment member is made of a graphite composite. Use of a rigid and flat sail attachment member 907 provides for more stable operation and/or less stress on a small sail area, as opposed to other approaches, e.g., where a ring or multiple rings are attached to the sail material and the tension cables are attached to the ring or rings.

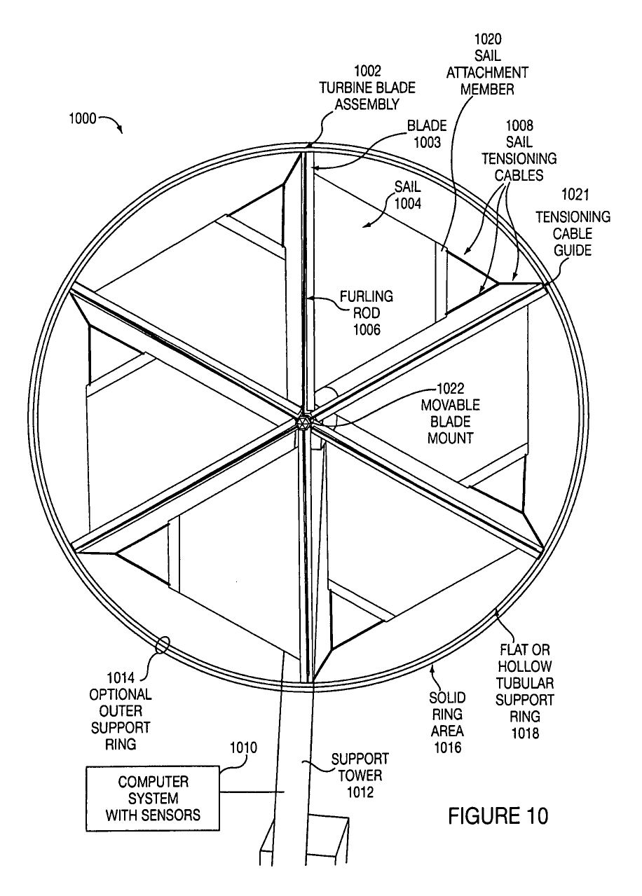

FIG. 10 is a drawing of a front view of the exemplary wind energy capture system 1000 including sails in which the sails have been unfurled to a second level, the second level being higher than the first level indicated by FIG. 9. Exemplary windmill 1000 includes a turbine blade assembly 1002, a support tower 1012, and a computer system 1010 with sensors. Turbine blade assembly 1002 also includes a turbine blade 1003, a furling rod 1006 situated inside hollow blade 1003, sail 1004, sail attachment member 1020, sail tensioning cables 1008, and tensioning cable guide 1021. In some embodiments, wind energy capture system 1000 includes an optional outer support ring 1014. Optional outer support ring 1014 includes a solid ring area 1016 and/or a flat or hollow tubular support ring 1018. Optional outer support ring 1014 reduces tip to tip drag on the turbine blades. In some embodiments, the optional outer support ring 1014 helps to avoid bird strikes, e.g., it is a bird avoidance ring.

Turbine blade assembly 1002 also includes a movable blade mount 1022. The root ends of the hollow blades are attached to the movable blade mount 1022 of the hub assembly. The movable blade mount 1022 allows a hollow blade 1003 to be rotated in a plane perpendicular to a plane in which the hollow blade 1003 extends outward from the hub assembly. In some embodiments, each of the blades 1003 of the blade assembly 1002, when rotated, are controllably rotated in unison in a coordinated action.

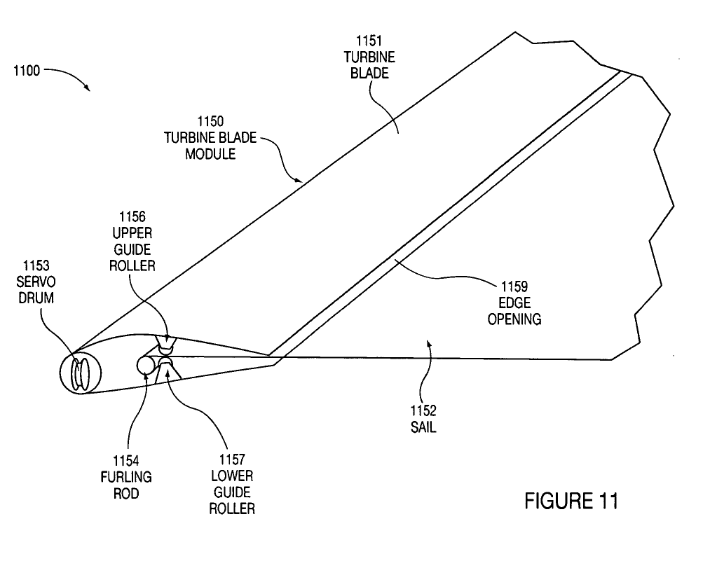

FIG. 11 is a drawing of an exemplary root end of a turbine blade module 1150 illustrating various features. Turbine blade module 1150 includes hollow turbine blade 1151, furling rod 1154, upper guide roller 1156, lower guide roller 1157, and servo drum 1153. Sail 1152 which is attached to furling rod 1154 passes through edge opening 1159 of hollow turbine blade 1151. The upper and lower guide rollers (1155, 1157) are anti-jam rollers. The servo drum 1153 is attached to a sail tensioning cable of a sail which is furled on a furling rod of adjacent blade.

The edge opening 1159 extends along the length of one side hollow turbine blade 1151 through which the sail 1152 can be unfurled and retracted. The lower guide roller 1157 is mounted inside the hollow blade 1151 and extends along the length of the opening 1159 to guide the sail as it is unfurled and retracted. The upper guide roller 1156 is mounted inside the hollow blade 1151 and extends along the length of the edge opening 1152 to guide the sail 1552 as it is furled and retracted.

The root blade end of the turbine blade 1151 is secured to a hub assembly of a turbine blade assembly. Servo drum 1153 which is attached to a sail tensioning cable of an adjacent turbine blade module of the turbine blade assembly is used to spool in or spool out the adjacent sail's tensioning cable, e.g., as part of the adjacent blade module's sail unfurling or sail retraction operations.

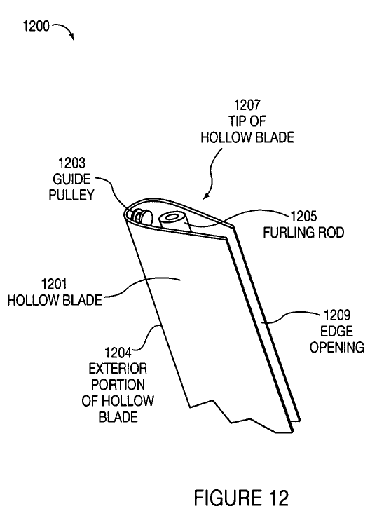

FIG. 12 is a drawing of a portion of an exemplary tip end of exemplary turbine blade module 1200 which can be used in any one of the embodiments shown herein which use sails. Exemplary turbine blade module 1200 includes a hollow blade 1201 with an edge opening 1209 and exterior portion of the hollow blade 1204. The exterior portion 1204 has a wing shape. The shape of the exterior portion 1204 changes along the length of the blade. There is a twist from tip to hub to reflect the effect of the wind. There is a higher pitch toward the center (hub) and a lower pitch toward the tip. The relative direction corresponds to a plane of rotation. In some embodiments, the twist of the blade is controllable, e.g., the blade can have hydraulics on one side and nitrogen on the other side which can force the blade to twist. The blade can thus have a minimal cross section and be controllably twisted, to capture wind or to change the amount of wind captured.

Exemplary blade assembly 1200 includes a tip end 1207, which is covered over but is shown in FIG. 12 without the cover so that the internal components can be seen. One end of the furling rod 1205 is located at the tip end 1207 of the hollow blade 1201, and a sail tensioning cable guide pulley 1203 is also located at the tip end 1207. The hollow blade 1201 also includes an edge opening 1209 through which a sail attached to furling rod 1205 can be unfurled or retracted. The tensioning cable guide pulley 1203 is part of a sail tensioning cable guide for a sail of an adjacent blade in a turbine blade assembly.

FIG. 13 is another drawing of an exemplary root end of a turbine blade module 1300, which illustrates additional detail and features. The root end shown in FIG. 13 may be the root end of the module 1200 shown in FIG. 12. Turbine blade module 1300 includes hollow turbine blade 1301, furling rod 1306, servo module 1305, drum 1310, servo module 1312 and cable 1308. The furling rod 1306 is attached to servo module 1305 and sail 1302. The servo module 1305 includes a hydraulic or electric drive servo and a position sensor. The sail 1302 is moved through edge opening 1304 as the furling rod 1306 is moved under control of servo module 1305 to cause the sail to be unfurled or retracted. Servo 1305 can also be controlled to lock the furling rod 1306 in position, e.g., at a certain sail deployment setting position Drum 1310 is attached to cable 1308, e.g., a cable for unfurling an adjacent blade's sail and for maintaining tension on the adjacent blade's sail. Drum 1310 is coupled to servo module 1312 which is a hydraulic or electric servo for controlling the drum rotation. Servo module 1312 includes a position sensor and a tension sensor. For example, if it is desired to increase the amount of sail surface area exposed to wind, then, servo 1312 is controlled to rotate drum 1310 such as to roll up more cable, resulting in more sail being pulled out of the adjacent blade's edge opening slot. In some embodiment, a certain level of residual pressure is maintained on the sail tensioning cable, e.g., to allow the sail to capture wind energy, yet to prevent the sail from tearing due to a sudden wind gust. In some embodiments the operation of the servos (1305, 1312) are computer controlled based on wind speed. For example, in response to a decrease in wind speed, when more sail is available to be unfurled, more sail is automatically unfurled, while in response to an increase in wind speed some sail, where some sail is already unfurled, some sail is retracted in.

It may be observed that hollow blade 1301 is curved more on a first surface 1315, which is to be positioned facing away from the wind direction 1319, than a second surface 1317, which is to be positioned facing into the wind 1319. This causes the blade 1301 to act as an airfoil. The turbine blade modules described in FIGS. 11, 12 and 13 may be utilized in any of the turbine blade assemblies of any of the wind energy capture systems shown or described in this application, e.g., systems of FIGS. 1, 5, 6, 7, 8, 9, 10, 14, 15, or 16.

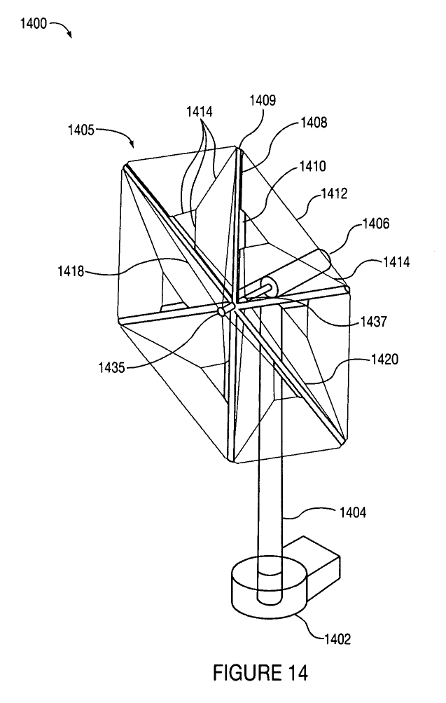

FIG. 14 is a drawing of an exemplary wind energy capture system 1400 in accordance with an exemplary embodiment. Exemplary wind energy capture system 1400 uses tensioning cables instead of an outer support ring. Exemplary wind energy capture system 1400 includes a generator drive building including a concrete support base 1402, a support tower 1404, a main housing 1406, and a turbine blade assembly 1405. The turbine blade assembly 1405 includes hollow blades 1408 with blade tips 1409, sail attachment members 1410, sail tension cables 1414, front ring of hub assembly 1435, rear ring 1437, blade spacing cables 1412, front blade tensioning cables 1418 and rear blade tensioning cables 1420.

A front blade tensioning cable 1418 goes between a blade tip 1409 and front ring of the hub assembly 1435, while a rear blade tensioning cable 1420 goes between a blade tip 1409 and the rear ring of the hub assembly 1437. There are a set of front blade tensioning cables 1418 extending from the front ring of the hub assembly 1435, each front blade tensioning cable 1418 being secured to the front ring 1435 and to a tip 1409 of a corresponding hollow blade 1408 of the turbine blade assembly 1405. There are a set of rear blade tensioning cables 1420 extending from the rear ring of the hub assembly 1437, each rear blade tensioning cable 1420 being secured to the rear ring 1437 and to a tip 1409 of a corresponding hollow blade 1408 of the turbine blade assembly 1405.

There are a set of blade spacing cables 1412. A blade spacing cable 1412 extends from the tip of a hollow blade 1409 to the tip of an adjacent hollow blade. The blade spacing cables 1412 are useful in distributing loads.

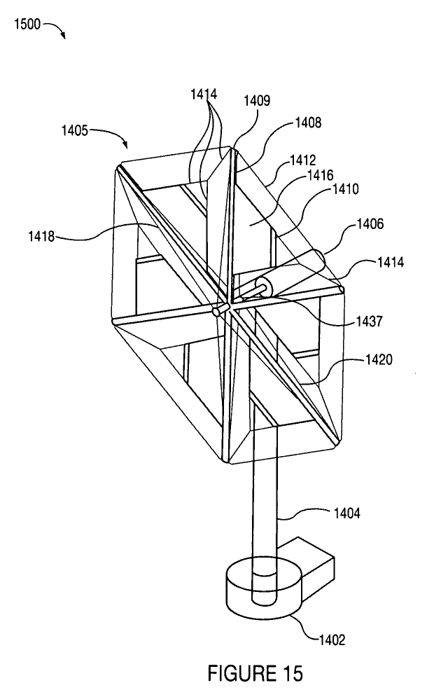

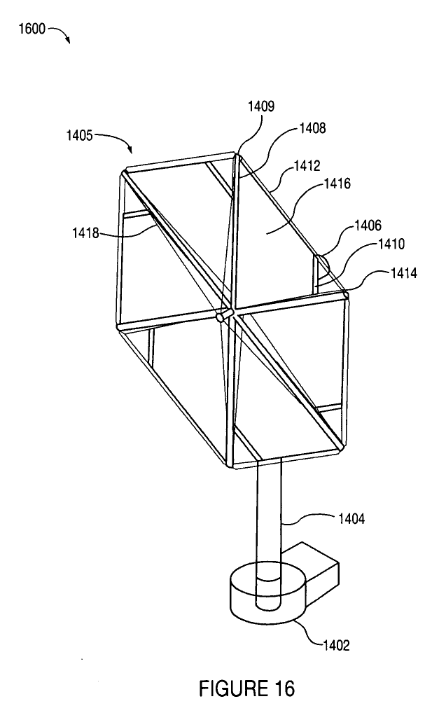

In the drawing of FIG. 14, the sails are almost fully furled in, e.g., corresponding to a very high wind conditions. FIG. 15 shows a drawing 1500 of the exemplary wind energy capture system of FIG. 14, with the sails 1416 unfurled to an intermediate position, e.g., corresponding to a intermediate level of wind. FIG. 16 shows a drawing 1600 of the exemplary wind energy capture system of FIG. 14, with the sails 1416 unfurled to an almost maximum position, e.g., corresponding to a very low level of sensed wind.

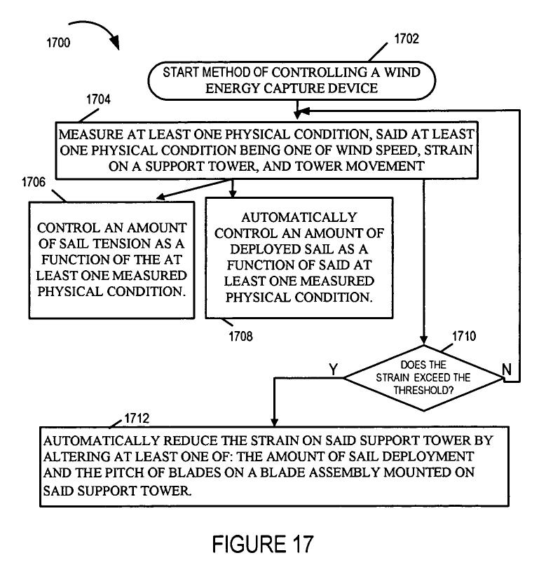

FIG. 17 is a drawing of a flowchart 1700 of an exemplary method of controlling a wind energy capture device in accordance with an exemplary embodiment of the present invention. The wind energy capture device may be any one of the exemplary wind energy capture systems of FIG. 5-10 and FIGS. 14-16 which can use the sensors of the type shown in FIG. 1 and the exemplary computer control module of FIG. 2. The computer control module included as part of the wind energy capture system may be used in implementing the method of flowchart 1700. Operation starts in step 1702 where the control method is initiated. Operation proceeds from start step 1702 to steps 1704.

In step 1704, which is performed on a recurring basis, the wind energy capture system uses one or more sensors to physical conditions. One or more of the following physical conditions are measured with at least one of them being measured: wind speed, strain on a support tower, and tower movement. Then operation proceeds to step 1706, 1708 and 1710, which may be performed in parallel or sequentially.

In step 1706, the wind energy capture device controls an amount of sail tension as a function of the at least one physical condition, i.e. one of the measured physical conditions, e.g. wind speed, strain on a support tower, and tower movement. In some embodiments controlling the amount of sail tension includes controlling a sail cable tensioning servo to apply a computer determined amount of tension to a sail tensioning cable. In step 1708 the wind energy capture device automatically controls an amount of deployed sail as a function of said at least one measured physical condition. In some embodiments controlling the amount of deployed sail includes controlling one or more furling rod servos to rotate. In such an embodiment, when adjusting sail deployment at least one furling rod will be rotated until the deployed amount of sail corresponds to the automatically determined amount. This may be an amount required to maintain a particular rotational velocity as the wind speed changes or it may be an amount intended to reduce wind strain on the support tower, e.g., due to heavy wind conditions. Thus, in some embodiments the amount of deployed sail is varied as changes in measured physical conditions are detected to maintain a rate of blade rotation within a predetermined range of rotational rates.

In step 1710, which may be performed in parallel with steps 1706 and 1708, a determination is made when the strain on said support tower exceeds a threshold. In step 1710 if it is determined that the strain on the tower exceeds a threshold, e.g., a predetermined operational or safety threshold, operation proceeds to step 1712. Otherwise operation proceeds again to measuring step 1704. In step 1712 the strain on said support tower is automatically reduced. This is done in some embodiments by altering at least one of: the amount of sail deployment and the pitch of blades on a blade assembly mounted on said support tower. More than one action may be taken depending on the severity of the strain, e.g., as indicated by the strain sensors.

In various embodiments elements described herein are implemented using one or more modules to perform the steps corresponding to one or more methods of the present invention. Thus, in some embodiments various features of the present invention are implemented using modules. Such modules, in the case of control or memory module, may be implemented using software, hardware or a combination of software and hardware. Many of the above described methods or method steps can be implemented using machine executable instructions, such as software, included in a computer readable medium such as a memory device, e.g., RAM, floppy disk, etc. to control a machine, e.g., general purpose computer with or without additional hardware, to implement all or portions of the above described methods. Accordingly, among other things, the present invention is directed to a computer-readable medium including machine or computer executable instructions for causing a machine, e.g., processor and associated hardware which may be part of a test device, to perform one or more of the steps of the above-described method(s).

Numerous additional variations on the methods and apparatus of the present invention described above will be apparent to those skilled in the art in view of the above description of the invention. Such variations are to be considered within the scope of the invention.

What is claimed is:

1. A wind blade assembly comprising:
a central hub assembly; and
a plurality of blade modules mounted to the central hub assembly, said plurality of blade modules including a first blade module and a second blade module, said first and second blade modules being attached to said central hub assembly at one end, the first blade module including:
i) a first hollow blade;
ii) a first retractable sail; and
iii) a first tensioning cable guide used for guiding a sail tensioning cable which provides tension for a retractable sail included in said second blade module.

2. The wind blade assembly of claim 1,
wherein said first blade module further includes:
iv) a furling rod extending inside said first blade assembly in a direction extending out from said central hub assembly, a first end of said retractable sail being secured to said furling rod; and
wherein said first hollow blade includes an edge opening extending along the length of one side of said first hollow blade through which said first sail can be unfurled and retracted.

3. The wind blade assembly of claim 2, wherein said first blade module further includes:
v) a lower guide roller mounted inside said first hollow blade and extending along the length of said opening to guide said first sail as it is unfurled and retracted.

4. The wind blade assembly of claim 3, wherein said first blade assembly further includes:
vi) an upper guide roller mounted inside said first hollow blade and extending along the length of said opening to guide said first sail as it is unfurled and retracted.

5. The wind blade assembly of claim 2,
wherein said first hollow blade is secured at a root end to said hub assembly; and
wherein said first tensioning cable guide includes a pulley mounted at a location closer to a tip end than the root end of the hollow blade.

6. The wind blade assembly of claim 5, wherein said sail tensioning cable extends around said pulley in a first direction toward said second blade module and toward said sail included in said second blade module for which sail cable tensioning is provided, and wherein an angle of 90 degrees is formed between said first direction and a second direction in which said second blade module is extended.

7. The wind blade assembly of claim 5, wherein said location is at said tip end of the hollow blade.

8. The wind blade assembly of claim 5, further comprising:
a sail tensioning servo mounted at the root end of said first blade module;
a drum attached to said sail tensioning servo around which said first sail tensioning cable is wrapped, said sail tensioning servo controlling the position of said drum to apply tension to said sail tensioning cable.

9. The wind blade assembly of claim 8, further comprising:
a computer control system for controlling the tension applied by said sail tensioning cable as a function of detected wind speed.

10. The wind blade assembly of claim 5, wherein said first end of said first hollow blade is movably mounted to said hub assembly allowing said first hollow blade module to be rotated in a plane perpendicular to a plane in which said first hollow blade extends outward from said hub assembly.

11. The wind blade assembly of claim 10, wherein said first hollow blade is curved more on a first surface facing away from a wind direction than on a second surface facing into the wind, thereby causing said first hollow blade to act as an airfoil.

12. The wind blade assembly of claim 11, wherein the hollow blade is D shaped.

13. The wind blade assembly of claim 11, wherein said first blade module further includes:
a first sail attachment member attached to a trailing edge of said first sail, said first sail attachment member being secured to said sail and providing an attachment point for a sail tensioning cable.

14. The wind blade assembly of claim 13, wherein said plurality of blade modules includes an odd number of blade modules secured to said hub assembly and being uniformly spaced from one another around said hub assembly.

15. The wind blade assembly of claim 2, further comprising:
a blade support ring secured to the tip of each of the hollow blades included in each of said plurality of blade modules.

16. The wind blade assembly of claim 14, further comprising:
a set of blade spacing cables, a blade spacing cable extending from the tip of each hollow blade in said plurality of blade modules to the tip of an adjacent hollow blade.

17. The wind blade assembly of claim 14, further comprising:
a set of front blade tensioning cables extending from a front tensioning cable attachment member on said hub assembly, each front blade tensioning cable being secured to said front tensioning cable attachment member and to a tip of a corresponding hollow blade of said wind blade assembly.

18. The wind blade assembly of claim 17, further comprising:
a set of rear blade tensioning cables extending from a rear tensioning cable attachment member of said hub assembly, each rear blade tensioning cable being secured to said rear tensioning blade attachment member and to a tip of a corresponding hollow blade of said wind blade assembly.

19. The wind blade assembly of claim 18, further comprising:
at least one tension blade support for providing support for the blade, said tension blade support being mounted on one of said front blade tensioning cables and one of said rear blade tensioning cables, said first hollow blade passing through said tension blade support.

20. The wind blade assembly of claim 2, further comprising:
a servo module including:
i) a furling rod control servo connected to said furling rod for controlling the position of said furling rod; and
ii) a position sensor for detecting the position of said furling rod.

21. A wind blade assembly comprising:
a central hub assembly; and
a plurality of blades mounted to the central hub assembly, each blade in said plurality of blades including a root end and a tip end, the root end being attached to said central hub assembly; and
a set of front blade tensioning cables extending from a front tensioning cable attachment member on said central hub assembly, each front blade tensioning cable being secured to said front tensioning cable attachment member and to a tip of a corresponding blade.

22. The wind blade assembly of claim 21, further comprising:
a set of rear blade tensioning cables extending from a rear tensioning cable attachment member of said hub assembly, each rear blade tensioning cable being secured to said rear tensioning blade attachment member and to a tip of a corresponding hollow blade of said wind blade assembly.

23. The wind blade assembly of claim 22, further comprising:
at least one tension blade support for providing support for one of said plurality of blades, said tension blade support being mounted on the front and the rear blade tensioning cables corresponding to said one of the plurality of blades, said one of said plurality of blades passing through said tension blade support.

24. The wind blade assembly of claim 22, further comprising:
a blade support ring secured to the tip of each said plurality of blades.

25. The wind blade assembly of claim 22, further comprising:
a set of blade spacing cables, a blade spacing cable extending from the tip of one blade in said plurality of blades to the tip of an adjacent blade in said plurality of blades.

26. A method of controlling a wind energy capture device, the method comprising:
measuring at least one physical condition, said at least one physical condition being one of wind speed, strain on a support tower, and tower movement; and
controlling an amount of sail tension as a function of the at least one physical condition.

27. The method of claim 26, wherein controlling the amount of sail tension includes controlling a sail cable tensioning servo to apply a computer determined amount of tension to a sail tensioning cable.

28. The method of claim 27, further comprising:
automatically controlling an amount of deployed sail as a function of said at least one physical condition, wherein controlling the amount of deployed sail includes:
controlling a furling rod servo to rotate a furling rod until the deployed amount of sail corresponds to the automatically determined amount.

29. The method of claim 28, further comprising:
determining when the strain on said support tower exceeds a threshold; and
automatically reducing the strain on said support tower when it is determined that the threshold has been exceeded by altering at least one of: i) the amount of sail deployment and ii) the pitch of blades on a blade assembly mounted on said support tower.

30. The method of claim 28, wherein the amount of deployed sail is varied as changes in measured physical conditions are detected to maintain a rate of blade rotation within a predetermined range of rotational rates.
